(19) United States
(12) Patent Application Publication
(10) Pub. No.: US 2009/0144358 A1
(43) Pub. Date: Jun. 4, 2009

(54) DECENTRALIZED PROCESSING APPARATUS, PROGRAM, AND METHOD

(75) Inventor: Taketoshi YOSHIDA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/271,894

(22) Filed: Nov. 15, 2008

(30) Foreign Application Priority Data
Nov. 16, 2007 (JP) 2007-298556

(51) Int. Cl. G06F 15/16

(52) U.S. Cl. 709/202

(57) ABSTRACT

A decentralized processing apparatus comprising: an executing unit to execute processing of an assigned first job; a receiving unit to receive a request for transferring a processing result of the first job, which is obtained by executing the processing of the assigned first job; a specifying unit to specify, based on the transfer request received by the receiving unit, an agent which is an assignment target of a second job to be processed by using the processing result of the first job; and a transmitting unit to transmit the processing result of the first job to the agent specified by the specifying unit.

### CROSS REFERENCE TO RELATED APPLICATION

This application is based upon and claims the benefit of priority of the prior Japanese Application No. 2007-298556, filed on Nov. 16, 2007, the entire contents of which are incorporated herein by reference.

### BACKGROUND OF THE INVENTION

1. Field of the Invention

The present invention relates to a decentralized processing technique in a grid computing system in which a master computing machine (such as a master computer or server, hereinafter referred to simply as a “master”) controls a plurality of agent computing machines (such as agent computers or servers, hereinafter referred to simply as an “agent”) to perform decentralized processing.

2. Description of the Related Art

Hitherto, jobs have been transferred between a master and a group of agents, which are capable of communicating with each other via a network, in accordance with the following flow. First, the master loads, into one agent, data to be used for a job and for processing the job. Having received the loaded data, the agent then executes the processing of the job. Further, the same agent returns the processing result of the job to the master. The master, having received the processing result, loads the job processing result and a job, which is to be the next one to be processed based on the processing result, to the same or another agent. By repeating the aforementioned operations, all the jobs are executed by the agent(s) with the decentralized processing.

Japanese Patent Application Publication No. 2005-208922 discloses a technique for determining a resource computer to which a job is assigned, taking into account a processing capability (data size/processing time) between a grid mediating apparatus corresponding to the master and the resource computer corresponding to the agent.

In addition to the grid computing system in which the master controls the plurality of agents to perform the decentralized processing, there is also a technique of causing one of two computers A and B, which has a surplus capacity, to execute a program.

Japanese Patent Application Publication No. 2002-99521 discloses a technique for determining which one of first and second procedures is to be employed, depending on respective operating situations and processing capabilities of two computers A and B. In the first procedure, between the computer A having a program and the computer B having data to be provided for the program, the computer B provides the data to the computer A, whereas the computer A outputs a processing result according to the program by using the data and transfers the processing result to the computer B. In the second procedure, the computer A provides the program to the computer B, whereas the computer B outputs a processing result according to the program. In other words, this technique employs a computer system that includes a plurality of CPUs instead of a grid computing system in which the master controls the plurality of agents to perform the decentralized processing.

Japanese Patent Application Publication No. H8-147249 discloses a technique in which there is no master server for managing a first CPU and a second CPU which correspond to agents. Also, the job type assigned to each CPU is fixed. Accordingly, a job management attribute table is just transferred between the first and second CPUs, and a job execution result list is not transferred from the first CPU to the second CPU. For the job execution result list, the second CPU refers to a storage unit.

### SUMMARY

In the technique disclosed in the above-cited Japanese Patent Application Publication No. 2005-208922, however, the following issue arises when the processing result executed by a first resource computer is returned to the grid mediating apparatus. When the next job is to be processed by a second resource computer, the returned processing result from the first resource computer must be loaded into the second resource computer via the grid mediating apparatus. Accordingly, a transfer time of the returned processing result is prolonged and traffic on a network is increased.

The techniques disclosed in the above-cited Japanese Patent Application Publication No. 2002-99521 and Japanese Patent Application Publication No. H8-147249 are not related to a grid computing system in which the master controls the plurality of agents to perform the decentralized processing, and therefore they include no master. Accordingly, even in the case of trying to directly transfer the processing result from one resource computer to another resource computer without passing through the grid mediating computer in the above-cited Japanese Patent Application Publication No. 2005-208922, there is no proper way to determine the destination for loading the returned processing result to execute or process the next job.

Accordingly, described herein are various example embodiments that provide a decentralized processing technique which is operable to cut a transfer time of a job processing result between agents under control of a master, and to reduce traffic on a network between the master and a group of agents.

According to an example embodiment of the present invention, there is provided a decentralized processing apparatus comprising: an executing unit to execute processing of an assigned first job; a receiving unit to receive a request for transferring a processing result of the first job, which is obtained by executing the processing of the assigned first job; a specifying unit to specify, based on the transfer request received by the receiving unit, an agent which is an assignment target of a second job to be processed by using the processing result of the first job; and a transmitting unit to transmit the processing result of the first job to the agent specified by the specifying unit.

### BRIEF DESCRIPTION OF THE DRAWINGS

Embodiments are illustrated by way of example and not limited by the following figure(s).

FIGS. 1A to 1D illustrate explanatory views showing Job Loading Example 1 in a grid computing system 100 according to an example embodiment of the present invention;

FIGS. 2A to 2D illustrate explanatory views showing Job Loading Example 2 in the grid computing system 100 according to an example embodiment of the present invention;

FIGS. 3A to 3D illustrate explanatory views showing Job Loading Example 3 in the grid computing system 100 according to an example embodiment of the present invention;

FIG. 4 illustrates a hardware configuration of a decentralized processing apparatus according to an example embodiment of the present invention;

FIG. 5 illustrates the contents stored in a communication rate management table according to example embodiment of the present invention;

FIG. 6 illustrates the contents stored in a job management table according to example embodiment of the present invention;

FIG. 7 illustrates the contents stored in an agent management table according to example embodiment of the present invention;

FIG. 8 illustrates a functional configuration of a master according to an example embodiment of the present invention;

FIG. 9 illustrates a functional configuration of an agent according to example embodiment of the present invention;

FIG. 10 illustrates an agent-to-agent communication rate measurement sequence in the grid computing system according to example embodiment of the present invention;

FIG. 11 illustrates a decentralized processing sequence in the grid computing system according to example embodiment of the present invention;

FIG. 12 illustrates a processing procedure of a job assignment process (e.g., S1102 and S1108 in FIG. 11), according to example embodiment of the present invention;

FIG. 13 illustrates a detailed processing procedure of a job ID assignment process (e.g., S1201 in FIG. 12), according to example embodiment of the present invention;

FIG. 14 illustrates a processing procedure of an estimated processing time calculation process (e.g., S1202 in FIG. 12), according to example embodiment of the present invention;

FIG. 15 illustrates a processing procedure of a process of calculating an estimated processing time (e.g., S1404 in FIG. 14), according to example embodiment of the present invention;

FIGS. 16A-B illustrate a processing procedure of an assignment target determination process (e.g., S1203 in FIG. 12), according to example embodiment of the present invention;

FIG. 17 illustrates a processing procedure of a cluster forming process (e.g., S1612 in FIG. 16B), according to example embodiment of the present invention;

FIG. 18A illustrates an explanatory view showing decentralized processing of a series of jobs in time sequence of (A) to (C), according to example embodiment of the present invention;

FIG. 18B illustrates an explanatory view showing decentralized processing of the series of job in time sequence of (D) to (F), according to example embodiment of the present invention;

FIG. 19 illustrates the contents stored in a job management table 600 when an assignment target for a job J1 is determined in (A) of FIG. 18A, according to example embodiment of the present invention;

FIG. 20 illustrates the contents stored in the job management table 600 when processing information of the job J1 is registered in (B) of FIG. 18A, according to example embodiment of the present invention;

FIG. 21 illustrates the contents stored in the job management table 600 when assignment target candidates for a job J1-1 are narrowed in (B) of FIG. 18A, according to example embodiment of the present invention;

FIG. 22 illustrates an explanatory table showing transfer times to assignment target candidates for the job J1-1, which are registered in (B) of FIG. 18A, according to example embodiment of the present invention;

FIG. 23 illustrates the contents stored in the job management table 600 when assignment target candidates for a job J1-2 are narrowed in (C) of FIG. 18A, according to example embodiment of the present invention;

FIG. 24 illustrates the contents stored in the job management table 600 when assignment target candidates for a job J1-3 are narrowed in (D) of FIG. 18B, according to example embodiment of the present invention;

FIG. 25 illustrates the contents stored in the job management table 600 after processing information of the jobs J1-2 and J1-3 has been registered, according to example embodiment of the present invention;

FIG. 26 illustrates the contents stored in the job management table 600 when assignment target candidates for a job J1-4 are narrowed in (E) of FIG. 18B, according to example embodiment of the present invention; and

FIG. 27 illustrates the contents stored in the job management table 600 after the assignment target of the job J1-4 has been determined in (E) of FIG. 18B, according to example embodiment of the present invention.

### DESCRIPTION OF EXAMPLE EMBODIMENTS

Described herein are various embodiments for a decentralized processing technique. As referred herein, a “decentralized processing apparatus” is a computer or computing machine that is to operate as a master or agent in a grid computing system, and a “decentralized processing program” is a software program, application, or module installed in a decentralized processing apparatus.

A grid computing system according to one example embodiment of the present invention comprises a master and a group of agents which are capable of communicating with each other via a network, e.g., the Internet, an intranet, a LAN (Local Area Network) or a WAN (Wide Area Network). The agents may have different or same levels of processing capability and also have different or similar types of structure including an OS (Operating System), a hardware architecture, etc. Further, communication quality of the network may not be constant or standardized.

In such a grid computing system, the master successively produces an analysis program called a job and loads the produced job into a properly assigned agent. A job processing result itself is not returned to the master whenever and wherever the job is executed. Instead, the job processing result is transferred to the agent as an assignment target, where a next job is to be processed based on such a job processing result, without passing through the master.

If the assignment target (where the next job is to be processed by using the job processing result of a previous job) and the transfer target (which processes the previous job and generates the job processing result) are the same agent, the assignment target may be determined earlier and the job processing result may be transferred to the assignment target. Alternatively, the agent as the transfer target of the job processing result may be determined earlier, and the job to be processed by using the job processing result may be assigned to and loaded into the transfer target.

Further, the job processing result obtained with the processing in each assignment target may be returned to the master from each assignment target after all job processings have been completed. Therefore, traffic during the job processing may be reduced.

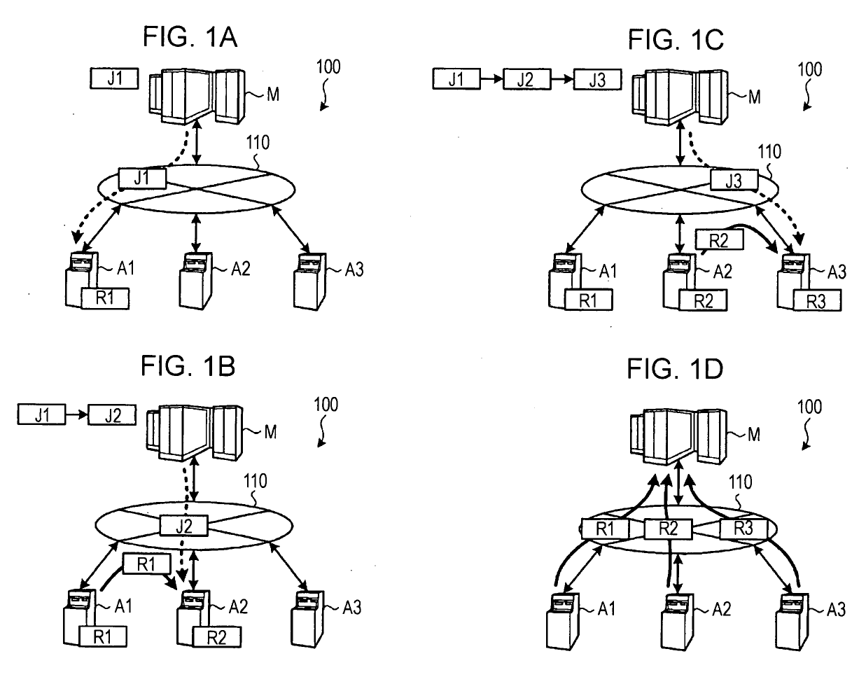

FIGS. 1A to 1D illustrate explanatory views showing a job loading in a grid computing system 100 according to an example embodiment. For simplicity of the explanation, FIGS. 1A to 1D illustrate three agents in the grid computing system 100 controlled by a master M. However, it should be understood that the master M may control any plurality of agents so as to perform decentralized processing via a network 110.

In FIG. 1A, the master M produces a job J1 and loads (or transmits) the job J1 (via the network 110) into the agent A1 that is designated as an assignment target of the job J1. The assignment target is determined by calculating respective estimated processing times of the job J1 in the agents A1 to A3. When processing of the job J1 is completed in the agent A1 into which the job J1 has been loaded, the agent A1 may return, to the master M, data indicating the completion of the processing of the job J1, the data size of a job processing result R1, the processing time of the job J1, and/or the CPU load of the agent A1. However, the job processing result R1 itself of the job J1 is not returned.

In FIG. 1B, the master M detects the completion of the processing of the job J1 and determines, as an assignment target of a newly produced next job J2, the agent A2 among the agents A1 to A3, which is not busy of processing any job. The assignment target is determined by calculating respective estimated processing times of the job J2 in the agents A1 to A3.

The job J2 is a job to be processed by using the job processing result R1 of the job J1. The master M loads the job J2 into the agent A2. Further, the master M transmits, to the agent A1 holding the job processing result R1, a request for transmitting the job processing result R1 to the agent A2. Upon receiving the transfer request, the agent A1 transfers the job processing result R1 to the agent A2, that is the assignment target of the job J2, without going through the master M.

The agent A1 continues to hold the job processing result R1 therein. When processing of the job J2 is completed in the agent A2 into which the job J2 has been loaded, the agent A2 may return, to the master M, data indicating the completion of the processing of the job J2, the data size of a job processing result R2, the processing time of the job J2, and/or the CPU load of the agent A2. Again, the job processing result R2 itself of the job J2 is not returned.

In FIG. 1C, as in FIG. 1B, the master M detects the completion of the processing of the job J2 and determines, as an assignment target of a newly produced next job J3, the agent A3 among the agents A1 to A3, which is not under processing of any job. The assignment target is determined by calculating respective estimated processing times of the job J3 in the agents A1 to A3. The job J3 is a job to be processed by using the job processing result R2 of the job J2. The master M loads the job J3 into the agent A3.

Further, the master M transmits, to the agent A2 holding the job processing result R2, a request for transmitting the job processing result R2 to the agent A3. Upon receiving the transfer request, the agent A2 transfers the job processing result R2 to the agent A3, which is the assignment target of the job J3, without passing through the master M. The agent A2 continues to hold the job processing result R2 therein.

When processing of the job J3 is completed in the agent A3, into which the job J3 has been loaded, the agent A3 returns to the master M data indicating the completion of the processing of the job J3, the data size of a job processing result R3, the processing time of the job J3, and/or the CPU load of the agent A3.

In FIG. 1D, when the completion of the processing of the final job J3 is detected, the master M transmits requests for acquiring the job processing results R1 to R3 to the agents A1 to A3 that have been the assignment targets. Upon receiving the acquisition requests, the agents A1 to A3 return the job processing results R1 to R3 held therein to the master M.

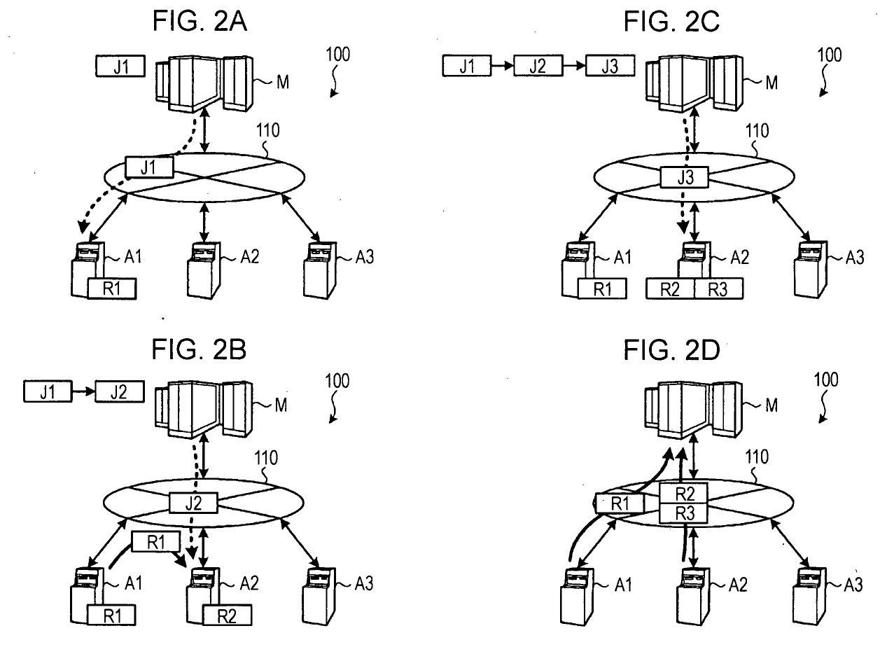

FIGS. 2A to 2D illustrate explanatory views showing a job loading in the grid computing system 100 according to another example embodiment. FIG. 2A to 2D represent the case where a request for transferring the job processing result is not to be issued from the master M in FIG. 2C. The processing in FIGS. 2A and 2B is similar to that in FIGS. 1A and 1B.

However, in FIG. 2C, the master M detects the completion of the processing of the job J2 as in FIG. 2B, but it determines, as an assignment target of a newly produced final job J3, the agent A2 among the agents A1 to A3, which is not busy processing any job and which has processed the previous job J2. The master M then loads the job J3 into the agent A2. In this case, because the agent A2 already holds the job processing result R2 and the job J3, the job processing result R2 is not to be transferred to another agent; thus, removing a request for transferring the job processing result to another agent. Consequently, a job processing result R3 of the job J3 is held in the agent A2 along with the job processing result R2.

In FIG. 2D, when the completion of the processing of the final job J3 is detected, the master M transmits requests for acquiring the job processing results R1 to R3 to the agents A1 and A2 that have been the assignment targets. Upon receiving the acquisition requests, the agents A1 and A2 return the job processing results R1 to R3 held therein to the master M.

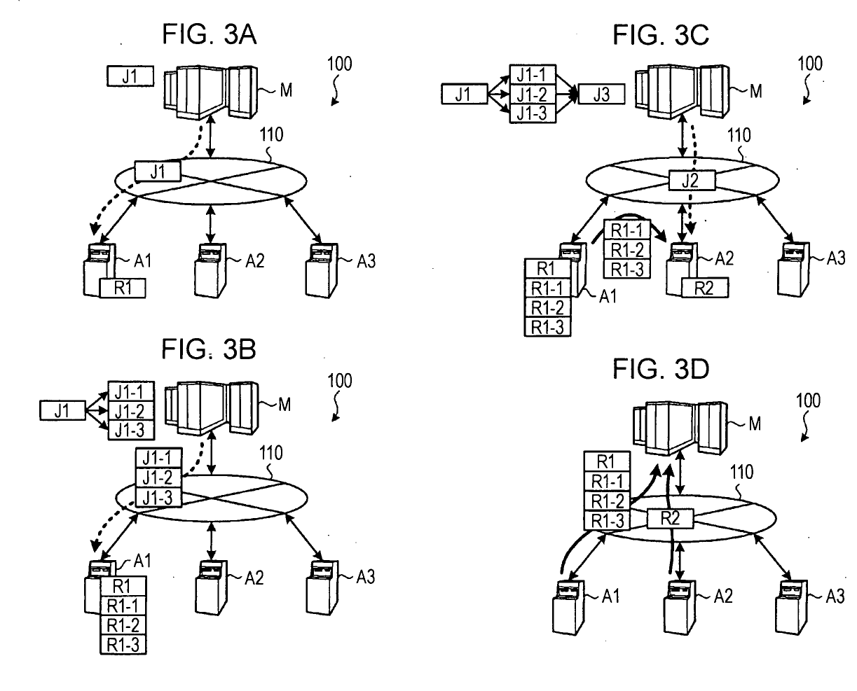

FIGS. 3A to 3D illustrate explanatory views showing a job loading in the grid computing system 100 according an example embodiment. FIGS. 3A to 3D represent the case of processing, in the form of a cluster, a plurality of jobs (three in FIG. 3, i.e., jobs J1-1 to J1-3) which are produced by the master M and are to be processed by using the processing result of a job (parent job, e.g., the job J1 in FIG. 3) which is common to the plurality of jobs. The processing in FIG. 3A is similar to that in FIG. 1A.

However, in FIG. 3B, the master M successively produces the jobs J1-1 to J1-3 that are to be processed by using the processing result R1 of the job J1. The master M determines the agent A1 as an assignment target of the initially produced job J1-1. Further, the master M collects a plurality of jobs into a cluster until a total of respective estimated processing times of the plurality of jobs exceeds the transfer time from the agent A1, which is the candidate of the assignment target, to another agent A2 or A3. In this illustrated case, a cluster made up of jobs J1-1 to J1-3 is produced. The master M loads the cluster (i.e., the jobs J1-1 to J1-3) into the agent A1.

In FIG. 3C, the master M detects the completion of processing of the cluster (i.e., the jobs J1-1 to J1-3) and determines, as an assignment target of a newly produced final job J2, the agent A2 which is not busy processing any job. The assignment target is determined by calculating respective estimated processing times of the job J2 in the agents A1 to A3. The job J2 is a job that is to be processed by using job processing results R1-1 to R1-3 of the cluster (i.e., the jobs J1-1 to J1-3). The master M loads the job J2 into the agent A2.

Also, the master M transmits, to the agent A1 holding the job processing results R1-1 to R1-3, a request for transmitting the job processing results R1-1 to R1-3 to the agent A2. Upon receiving the transfer request, the agent A1 transfers the job processing results R1-1 to R1-3 to the agent A2, which is the assignment target of the job J2, without passing through the master M. The agent A1 continues to hold the job processing results R1-1 to R1-3 therein.

When processing of the job J2 is completed in the agent A2 into which the job J2 has been loaded, the agent A2 returns to the master M data indicating the completion of the processing of the job J2, the data size of a job processing result R2, the processing time of the job J2, and/or the CPU load of the agent A2.

In FIG. 3D, when the completion of the processing of the final job J2 is detected, the master M transmits requests for acquiring the job processing results R1, R1-1 to R1-3, and R2 to the agents A1 and A2 that have been the assignment targets. Upon receiving the acquisition requests, the agents A1 and A2 return the job processing results R1, R1-1 to R1-3, and R2 held therein to the master M.

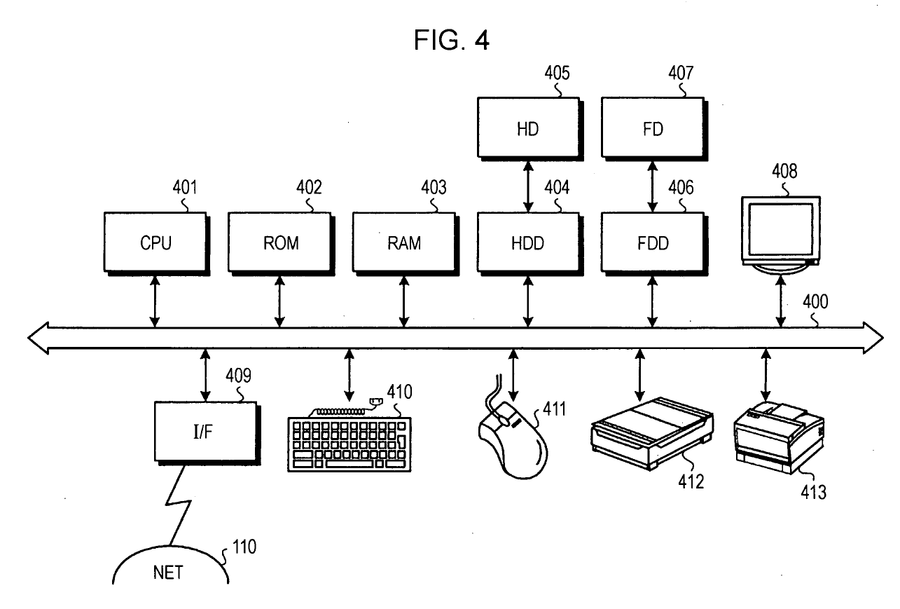

FIG. 4 illustrates a hardware configuration of the decentralized processing apparatus according to an example embodiment.

In FIG. 4, the decentralized processing apparatus comprises a CPU 401, a ROM 402, a RAM 403, an HDD (Hard Disk Drive) 404, an HD (Hard Disk) 405, an FDD (Flexible Disk Drive) 406, an FD (Flexible Disk) 407 as one example of a detachably attached recording medium, a display 408, an I/F (interface) 409, a keyboard 410, a mouse 411, a scanner 412, and a printer 413. Those components are interconnected via a bus 400.

The CPU 401 supervises overall control of the decentralized processing apparatus. The ROM 402 stores programs such as a boot program. The RAM 403 is used as a work area of the CPU 401. The HDD 404 controls read/write of data on the HD 405 under control of the CPU 401. The HD 405 stores data written under control of the HDD 404.

The FDD 406 controls read/write of data on the FD 407 under control of the CPU 401. The FD 407 stores data written under control of the FDD 406 and causes the decentralized processing apparatus to read the data stored in the FD 407.

As other examples of the detachably attached recording medium, a CD-ROM (CD-R or CD-RW), an MO, a DVD (Digital Versatile Disk), a memory card, etc. may also be used in addition to the FD 407. The display 408 displays a cursor, an icon, and a tool box, as well as data including documents, images, functional information, etc. For example, a CRT, a TFT liquid crystal display, or a plasma display may be employed as the display 408.

The I/F 409 is connected to the network 110, such as the Internet, via a communication line such that the decentralized processing apparatus is connected to another apparatus via the network 110. Further, the I/F 409 serves as an interface between the interior of the apparatus and the network 110, and it controls input/output of data from an external apparatus. For example, a modem or an LAN adaptor may be employed as the I/F 409.

The keyboard 410 includes keys for entering characters, numerals, various kinds of instructions, etc., to thereby input data. Alternatively, the keyboard 410 may have an entry pad and a ten-key numerical pad in the form of a touch panel. The mouse 411 is used, for example, to move a cursor, select a range, move a window, and to change a window size. As another pointing device, a track ball, a joystick or the like may also be used so long as it has a similar function.

The scanner 412 optically reads an image and takes image data into the decentralized processing apparatus. The scanner 412 may also have the OCR function. The printer 413 prints the image data and document data. For example, a laser printer or an ink jet printer may be employed as the printer 413.

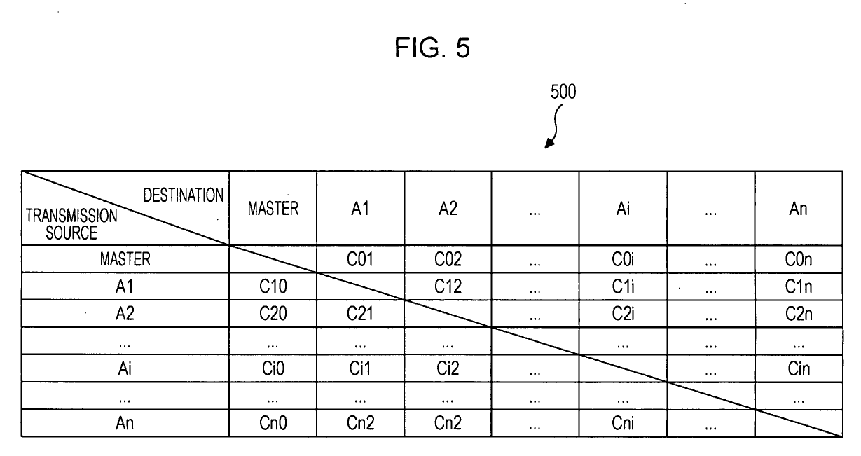

FIG. 5 illustrates the contents stored in a communication rate management table according to one example embodiment. A communication rate management table 500 is used to determine a transfer time of the job processing result. The communication rate management table 500 is incorporated in the master M. As shown in FIG. 5, the communication rate management table 500 stores respective communication rates between two agents and between the master and each of the agents.

In each agent, a computer serving as a transmission source measures the communication rate with respect to a computer at the destination upon receiving a request from the master M. The communication rate may be measured, for example, by a method of measuring a time from transmission of a “ping” command toward the destination to reception of a response. The function of the communication rate management table 500 is realized, for example, by using a recording area of the RAM 403 or the HD 405 shown in FIG. 4.

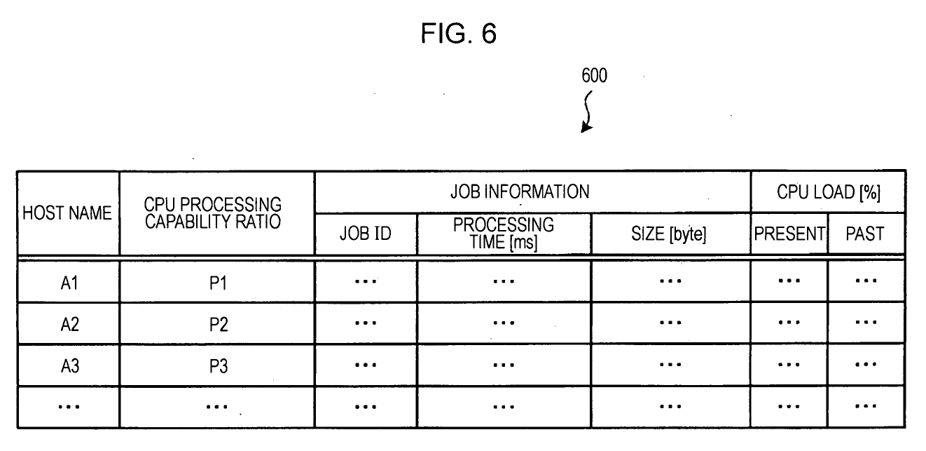

FIG. 6 illustrates the contents stored in a job management table according on example embodiment. A job management table 600 is used to determine an estimated processing time of a newly produced job in each agent. The job management table 600 is incorporated in the master M. As shown in FIG. 6, the job management table 600 stores, for each agent, a CPU processing capability ratio, job information, and a CPU load. As referred herein a “CPU processing capability ratio” indicates a proportion of the CPU processing capability of each agent on the basis of a particular CPU processing capability (e.g., a clock frequency).

The job information includes a job ID, a processing time, and a size. As referred herein, a “job ID” indicates a job ID code that is to be assigned or has been assigned to each agent. The job ID is stored when the master M assigns a job.

As referred herein, a “processing time” indicates an actual processing time for each agent to process the job that has been loaded into the relevant agent. As referred herein, a “size” indicates a data size of the job processing result obtained when the job is processed in the agent. The processing time and the size are information that is included in processing information returned from the agent into which the job has been loaded, and they are written when the processing information is received.

As referred herein, a “CPU load” indicates the CPU load of each agent. The CPU load before the loading of the job is the past CPU load, and the CPU load after the loading of the job is the present CPU load. The CPU load is information that is also included in the processing information returned to the master M, and it is written when the processing information is received. The function of the job management table 600 is realized, for example, by using a recording area of the RAM 403 or the HD 405 shown in FIG. 4.

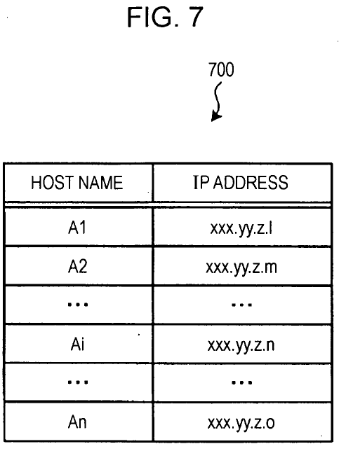

FIG. 7 illustrates the contents stored in an agent management table according to an example embodiment. An agent management table 700 is used to specify an IP address of the agent that becomes a job assignment target or the agent that becomes a transfer target of the job processing result. The agent management table 700 is incorporated in the master M. As shown in FIG. 7, the agent management table 700 stores the IP address for each agent. The function of the agent management table 700 is realized, for example, by using a recording area of the RAM 403 or the HD 405 shown in FIG. 4.

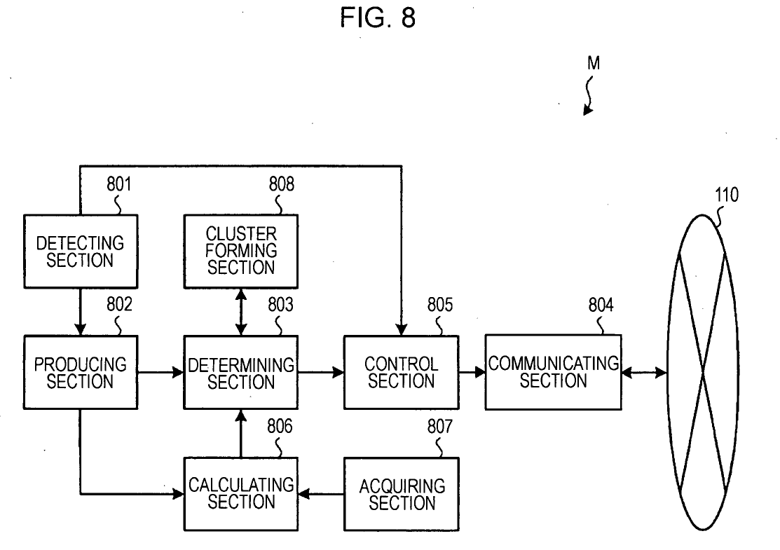

FIG. 8 illustrates a functional configuration of the master M according to an example embodiment. As shown in FIG. 8, the master M comprises a detecting section 801, a producing section 802, a determining section 803, a communicating section 804, a control section 805, a calculating section 806, an acquiring section 807, and a cluster forming section 808. The functions of those sections 801 to 808 may be implemented, for example, with the CPU 401 executing programs stored in a storage area of the ROM 402, the RAM 403 or the HD 405 shown in FIG. 4, or with the I/F 409.

The detecting section 801 is to detect that the processing of the job has been completed by the agent as the job assignment target. In practice, the completion of the job processing may be detected by receiving, from the agent in which the job processing has been completed, a message indicating the completion of the job processing, or the processing information that includes the job information, the CPU load, etc.

The producing section 802 is to produce a series of jobs. The series of jobs are linked to one another in a tree structure, starting from a head job, such that a subsequent processing of a job is executed by using the processing result of a preceding job, which serves as a parent. Also, whenever a job is produced, the producing unit 802 assigns a specific job ID to the job. For example, “J1” is assigned to a job that is first produced, and when a job to be processed by using the processing result of the job J1 is produced, “J2” is assigned to the newly produced job.

Further, when a group of jobs to be processed by using the processing result of a job common to the job group is produced, a job ID is assigned to each of the jobs in the group by using a branch number. For example, as shown in FIG. 3, job IDs “J1-1”, “J1-2” and “J1-3” are assigned to respective jobs in the job group that is to be processed by using the job processing result R1 of the common job J1. By assigning the job IDs in such a manner, the series of jobs may be recognized as a tree structure.

The determining section 803 is to determine, from among an agent group, an agent that becomes an assignment target of the job produced by the producing section 802. More specifically, when the completion of some job is detected, the determining section 803 determines an agent that becomes an assignment target of another job to be processed by using the job processing result of the relevant job. A process of determining the assignment target agent is performed based on an estimated processing time of the job, which is going to be assigned, in each agent. In practice, the agent having the shortest estimated processing time is determined as the assignment target. Alternatively, the assignment target agent may be determined as the agent having a higher communication rate with the respect to the master M, or at random.

The communicating section 804 is to communicate with the agent group. In practice, the communicating section 804 receives, e.g., the communication rate, the processing information, and the job processing result which are transmitted from the agent, and transmits various requests, jobs, etc. to the agent.

The control section 805 is to control the communicating section 804 and of controlling the communication with the agent group. For example, as shown in FIG. 1A, the request for processing the job J1 is transmitted to the agent A1 as the assignment target. Also, as shown in FIG. 1B, the request for transferring the job processing result R1 to the agent A2, i.e., the assignment target of the job J2, is transmitted to the agent A1 that holds the job processing result R1.

Further, as shown in FIG. 2C, when the assignment target or agent of the job J3 to be processed by using the job processing result R2 of the job J2 is the same as the agent holding the job processing result R2, the request for transferring the job processing result R2 is not transmitted. As shown in FIG. 1D, when the completion of processing of the final job J3 is detected, the requests for acquiring the job processing results R1 to R3 are transmitted to the agents A1 to A3 that have been the assignment targets.

The calculating section 806 is to calculate an estimated processing time of the job for each of job assignment target candidates selected from among the agent group. In practice, the estimated processing time of the assigned job is calculated for each assignment target candidate by referring to the job management table 600, for example. The estimated processing time can be calculated from the following formula (1).

Tpik=tpik×Lai/Lbi (1)

In the formula (1), Tpik is the estimated processing time of a job Jk in an agent Ai as the assignment target candidate. Also, tpik is the processing time of the job Jk in the agent Ai as the assignment target candidate, the processing time tpik being stored in the job management table 600. Lai is the present CPU load of the agent Ai as the assignment target candidate, the load Lai being stored in the job management table 600. Lbi is the past CPU load of the agent Ai as the assignment target candidate, the load Lbi stored in the job management table 600.

When the processing time of the job having been processed by using the same job processing result is stored, the stored processing time provides tpik. When the processing time of a job having substantially the same, or within a desired difference (e.g., at a difference of about 10% or less), data size as that of the job Jk is stored, the stored processing time provides tpik. When the processing time tpik may not be set as in the case of the initially produced job, for example, the estimated processing time is calculated from the following formula (2)

Tpik=1/Pi (2)

In the formula (2), Pi is the CPU processing capability ratio of the agent Ai as the assignment target candidate. The estimated processing time Tpik is calculated in the number of times corresponding to the number of the agents Ai as the assignment target candidates, and the shortest estimated processing time Tpik is selected.

The acquiring section 807 has the function of acquiring the communication rate between two agents. More specifically, prior to the execution of the decentralized processing, for example, a request for acquiring the communication rate with respect to another agent is transmitted to each agent. Upon receiving the acquisition request, each agent transmits, e.g., a “ping” command to the other agent and measures the communication rate with respect to the other agent. The master M receives the measured communication rate as a response, thereby acquiring the communication rate between the agents.

The acquired communication rate is written in the communication rate management table 500. Therefore, when the communication rate is needed, the relevant communication rate may be acquired from the communication rate management table 500 by designating the transmission source agent and the destination agent. For example, in FIG. 1B, when it is needed to acquire the communication rate between the agents A1 and A2, a communication rate C12 is read from the communication rate management table 500 by designating, as the transmission source, the agent A1 holding the job processing result R1 and, as the destination, the agent A2 as the assignment target of the job J2.

In the above-described case, the calculating section 806 calculates a transfer time of the job processing result from the agent holding the job processing result to the assignment target candidate based on both the data size of the job processing result and the communication rate acquired by the acquiring section 807. The transfer time may be calculated from the following formula (3).

Ttj=sj/Cmi (3)

In the formula (3), Ttj is the transfer time of a processing result Rj of a job Jj from an agent Am having processed the job Jj, which is a parent of the job Jk, to an agent Ai as the assignment target candidate of the job Jk, sj is the data size of the job processing result Rj, and Cmi is the communication rate when the agent Am is designated as the transmission source and the agent Ai is designated as the destination. The data size sj is stored in the job management table 600. The communication rate Cmi is stored in the communication rate management table 500.

Further, the determining section 803 is to compare the estimated processing time Tpik with the transfer time Ttj, which has been calculated by the calculating section 806, to thereby determine, as the assignment target, the agent that is the assignment target candidate. In the case of Tpik<Ttj, for example, the agent Ai as the assignment target candidate is determined as the assignment target agent for the job Jk. The assignment target agent Ai becomes also the transfer target of the job processing result Rj from the agent Am.

The cluster forming section 808 is to collect, into a cluster, a group of jobs produced by the producing section 802. The group of jobs to be collected into a cluster is a group of jobs that have a common parent job. One example of the cluster is the job group J1-1 to J1-3, shown in FIG. 3, which employs the processing result R1 of the parent job J1.

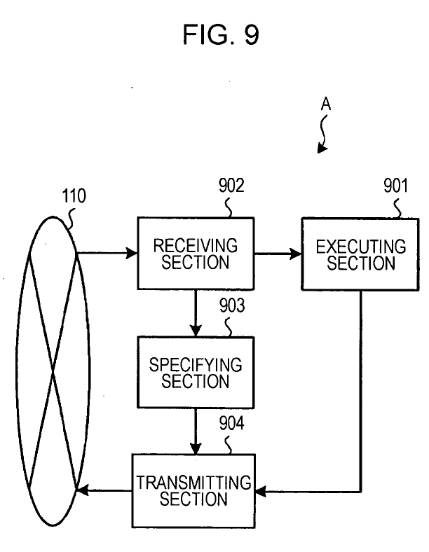

FIG. 9 illustrates functional configuration of the agent according to an embodiment. As shown in FIG. 9, the agent A comprises an executing section 901, a receiving section 902, a specifying section 903, and a transmitting section 904. In practice, the functions of those sections 901 to 904 are realized, for example, with the CPU 401 executing programs stored in a storage area of the ROM 402, the RAM 403 or the HD 405 shown in FIG. 4, or with the I/F 409.

The executing section 901 has the function of executing the processing of a job assigned by the master M. The processing of the job is executed by a CPU in the agent, and the job processing result is held in a storage area inside the agent.

The receiving section 902 has the function of receiving, from the master M, a request for transferring the processing result of the job, which has been obtained with the execution of the job in the executing section 901. Unless the transfer request or a request for acquiring the job processing result is received from the master M, the job processing result is not transmitted to another computer.

The specifying section 903 has the function of specifying an assignment target agent for a job, which is to be processed by using the job processing result, based on the transfer request received by the receiving section 902. An IP address of the assignment target agent is buried in the transfer request, and the specifying section 903 extracts the buried IP address.

The transmitting section 904 has the function of transmitting the job processing result to the agent that has been specified by the specifying section 903. The job processing result may be transferred by setting, as the designation, the IP address extracted from the transfer request.

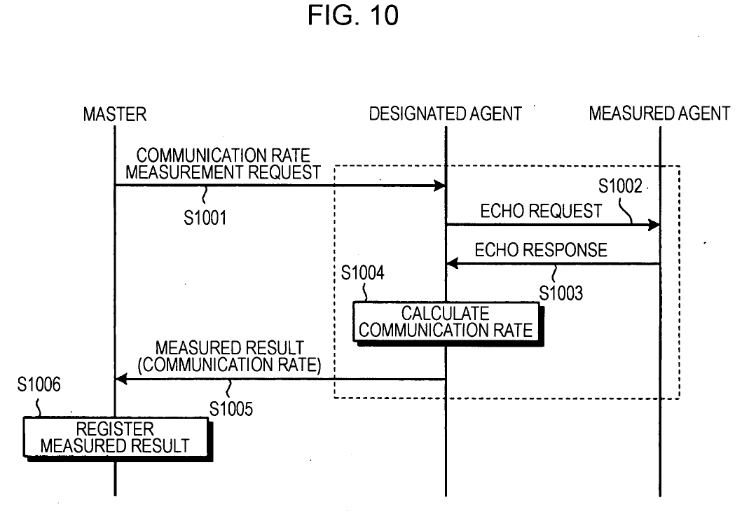

FIG. 10 illustrates an agent-to-agent communication rate measurement sequence in the grid computing system 100.

Referring to FIG. 10, the master M designates an agent that becomes a communication rate measurement target, and transmits a communication rate measurement request to the designated agent (at S1001). The communication rate measurement request includes IP addresses of both the designated agent, i.e., the communication rate measurement target, and an agent for which the measurement is to be executed.

Upon receiving the communication rate measurement request, the designated agent transmits an echo request in the form of a “ping” command to the measured agent (at S1002). Upon receiving the echo request, the measured agent replies an echo response to the designated agent (at S1003).

Based on the communication time from the transmission of the echo request to the reception of the echo response and respective data sizes of the echo request and the echo response, the designated agent calculates the communication rate when the designated agent is the transmission source and the measured agent is the destination (at S1004). Then, the designated agent transmits the calculated communication rate to the master M (at S1005). Upon receiving the communication rate, the master M registers it, as the measured result, in the communication rate management table 500 (at S1006).

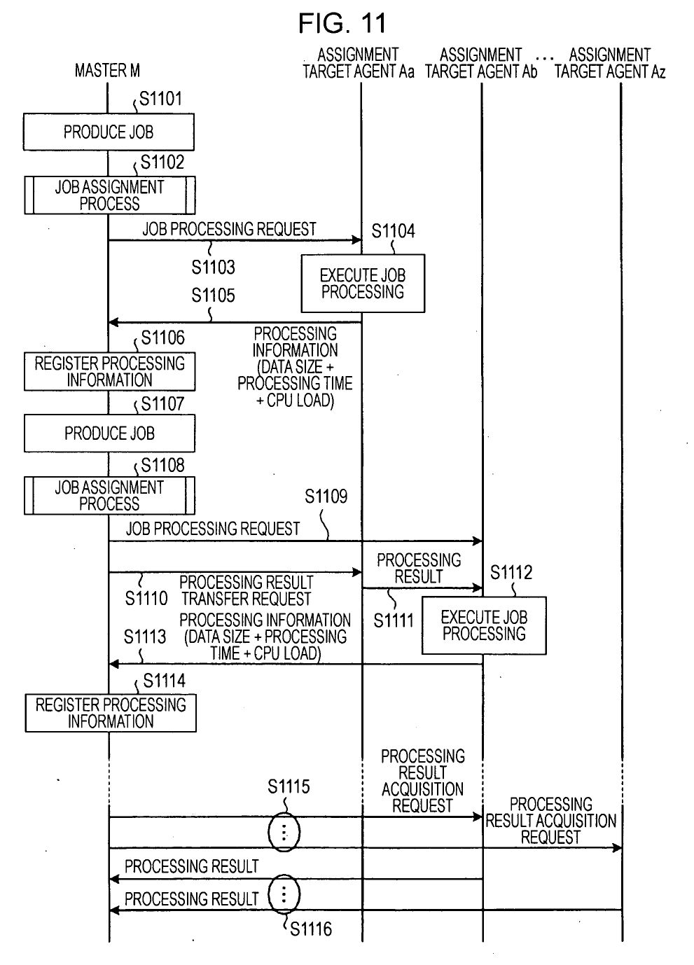

FIG. 11 illustrates a decentralized processing sequence in the grid computing system 100 according to an example embodiment. First, the master M produces an initial job (at S1101) and executes a job assignment process for the produced job (at S1102). Then, the master M transmits a job processing request to an assignment target agent Aa (at S1103). The job processing request includes the produced job.

Upon receiving the job processing request, the assignment target agent Aa executes job processing (at S1104). The data size of the obtained job processing result, the processing time, and the CPU loads before and after the processing are returned, as processing information, to the master M (at S1105). Upon receiving the processing information, the master M registers the received processing information in the job management table 600 (at S1106).

The master M produces a succeeding job (at S1107) and executes a job assignment process for the produced job (at S1108). Then, the master M transmits a job processing request to an assignment target agent Ab (at S1109). The job processing request includes the produced job. The succeeding job is a job to be processed by using the processing result of the job that has been processed by the agent Aa as the previous assignment target. Further, the master M transmits, to the agent Aa as the previous assignment target, a request for transferring the job processing result to a new assignment target agent Ab (at S1110).

Upon receiving the transfer request, the previous assignment target agent Aa transfers the job processing result to the new assignment target agent Ab (at S1111). When the processing result from the previous assignment target agent Aa and a job to be processed by using that processing result are both loaded, the new assignment target agent Ab executes processing of the loaded job (at S1112). The data size of the obtained processing result, the processing time, and the CPU loads before and after the processing are returned, as processing information, to the master M (at S1113). Upon receiving the processing information, the master M registers the received processing information in the job management table 600 (at S1114).

Thereafter, in the grid computing system 100, at S1107 to S1114 are repeatedly executed until the production of jobs is completed. When registration of the processing information of the final job is completed, the master M transmits requests for acquiring the processing results to the agents Aa to Az that have been the assignment targets (at S1115). Upon receiving the acquisition requests, the assignment targets Aa to Az return the respective processing results to the master M (at S1116). The decentralized processing of the series of jobs is then brought to an end.

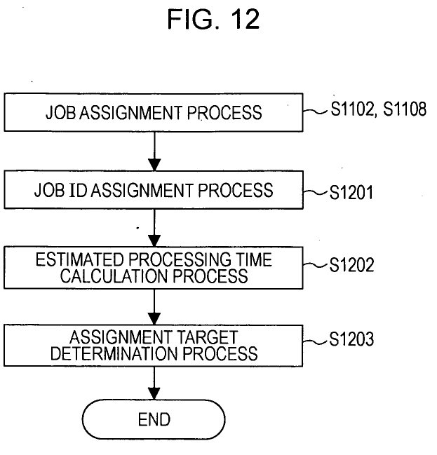

FIG. 12 illustrates a detailed processing procedure of a job assignment process (e.g., at S1102 and S1108 shown in FIG. 11) according to an example embodiment. Referring to FIG. 12, the master M first executes a job ID assignment process for the produced job (at S1201), then executes an estimated processing time calculation process (at S1202), and finally executes an assignment target determination process (at S1203). The job assignment process is thereby brought to an end.

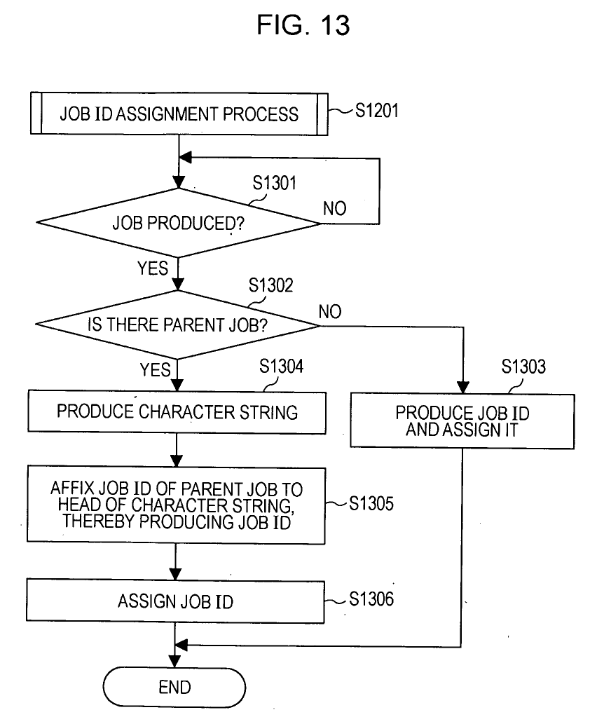

FIG. 13 illustrates a processing procedure of the job ID assignment process (at S1201) shown in FIG. 12. First, the master M waits for until a job is produced (No at S1301). If the job is produced (Yes at S1301), the master M determines whether there is a parent job, i.e., a job serving as a processing source of the processing result that is to be provided to the produced job (at S1302). For example, when the produced job is J1-2 in the case of FIG. 3, a parent job is the job J1.

If there is no parent job (No at S1302), the master M produces a job ID and assigns it to the relevant job (at S1303). The job ID assignment process is thereby brought to an end. On the other hand, if there is a parent job (Yes in at S1302), the master M produces a specific character string (at S1304) and affix the job ID of the parent job to the head of the character string, thereby producing a job ID of the presently produced job (at S1305). Then, the master M assigns the produced job ID to the relevant job (at S1306). The job ID assignment process is thereby brought to an end, followed by shifting to the estimated processing time calculation process.

In the example of FIG. 3, assuming that the job ID has been assigned up to the job J1-1 so far, a specific character string of “2” is produced for the presently produced job because there is the parent job J1. Note that the job J1-1 is already present and hence “1” may not be produced as the specific character string. By prefixing the job ID of the parent job, i.e., J1, to the produced character string “2”, the job ID, i.e., J1-2, of the presently produced job is assigned.

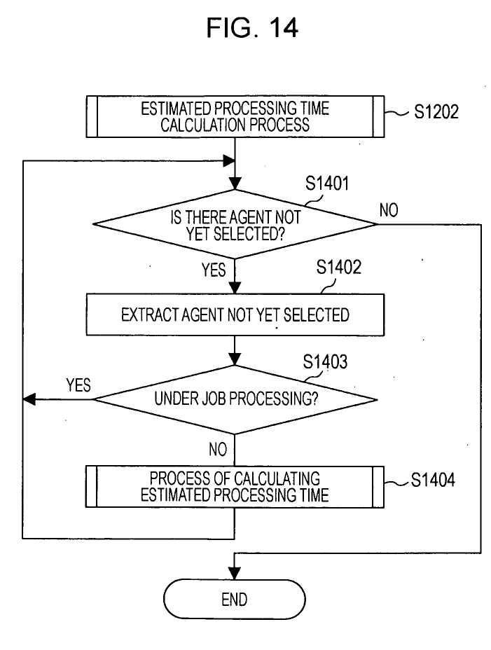

FIG. 14 illustrates a processing procedure of the estimated processing time calculation process (e.g., at S1202 in FIG. 12) according to one embodiment. First, the master M determines whether there is an agent not yet selected (at S1401). If there is an agent not yet selected (Yes at S1401), the master M extracts the not-yet-selected agent (at S1402). More specifically, the master M specifies an entry in the agent management table 700 corresponding to the not-yet-selected agent (at S1402). Then, the master M determines whether the not-yet-selected agent is under the job processing (at S1403).

If the not-yet-selected agent is under the job processing (Yes in at S1403), the master M returns to at S1401. On the other hand, if it is not under the job processing (No at S1403), the master M executes a process of calculating the estimated processing time (at S1404). When the estimated processing time is calculated, the master M returns to S1401. On the other hand, if there is no not-yet-selected agent at S1401 (No at S1401), the master M brings the estimated processing time calculation process to an end and shifts to the assignment target determination process (at S1203).

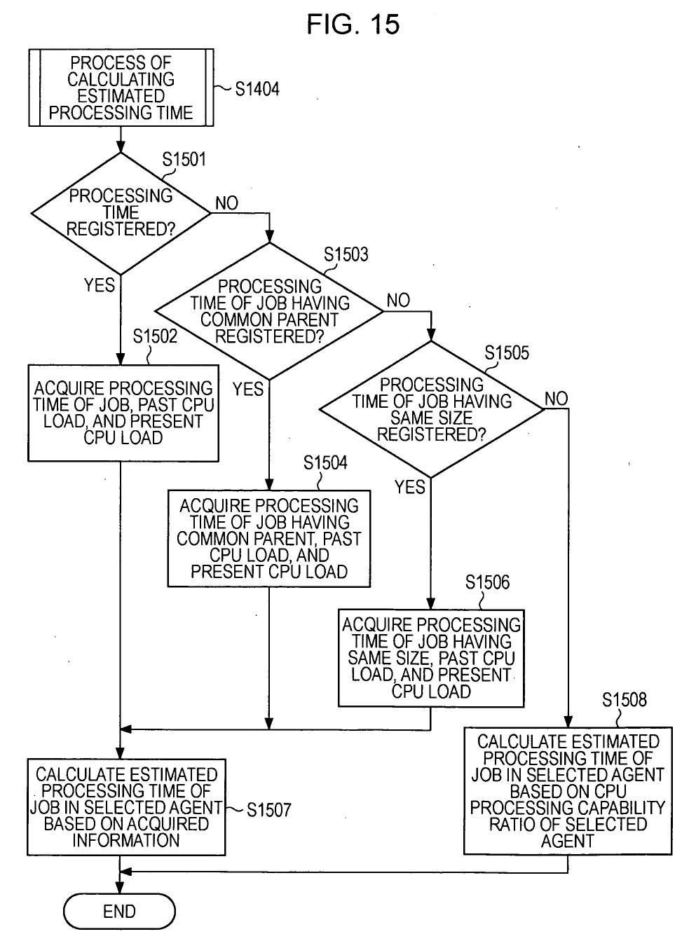

FIG. 15 illustrates a detailed processing procedure of the process of calculating the estimated processing time (e.g., at S1404 in FIG. 14) according to an embodiment. First, the master M determines whether the processing time is already registered (at S1501). If the processing time is already registered (Yes at S1501), the master M acquires the processing time, the past CPU load and the present CPU load from an entry in the job management table 600 corresponding to the selected agent (at S1502). Then, the master M shifts to S1507.

As referred herein, a “registered processing time” indicates the processing time of a job which is substantially the same as the presently produced job, but which has a parameter different from that given to the presently produced job. Because such a registered processing time is already registered in the job management table 600 prior to estimating the processing time of the presently produced job, it is employed to calculate the estimated processing time.

On the other hand, if the processing time is not registered (No at S1501), the master M determines whether the processing time of the job having the common parent is registered (at S1503). If it is registered (Yes at S1503), the master M acquires the processing time of the job having the common parent, the past CPU load and the present CPU load from an entry in the job management table 600 corresponding to the selected agent (at S1504). Then, the master M shifts to S1507.

The above-described processing is on substantially the same processing time of jobs having a common parent. For example, when calculating the estimated processing time of the job J1-2 in some agent, the estimated processing time of the job J1-2 in that agent is calculated by using the processing time of the job J1-1 that has the parent job J1 common to the job J1-2.

On the other hand, if the processing time is not registered (No at S1503), the master M determines whether the processing time of the job having substantially the same size is registered (at S1505). If it is registered (Yes at S1505), the master M acquires the processing time of the job having substantially the same size, the past CPU load and the present CPU load from an entry in the job management table 600 (at S1506). Then, the master M shifts to S1507.

The job having substantially the same size may be registered in the entry corresponding to the selected agent or in another entry. In the latter case, CPU loads in the registered entry are read as the CPU loads. Thus, the above-described processing is based on jobs have substantially the same size are to have substantially the same processing time.

At S1507, the master M calculates the estimated processing time of the job in the selected agent by using the information that has been acquired at S1502, S1504 or S1506. In practice, the estimated processing time is calculated by substituting individual values of the information in the above-mentioned formula (1). The process of calculating the estimated processing time is thereby brought to an end, followed by returning to S1401.

If the processing time is not registered at S1505 (No at S1505), the master M calculates the estimated processing time of the job in the selected agent by using the CPU processing capability ratio of the selected agent (at S1508). In practice, the estimated processing time is calculated by substituting the CPU processing capability ratio of the selected agent in the above-mentioned formula (2). The process of calculating the estimated processing time is thereby brought to an end, followed by returning to S1401.

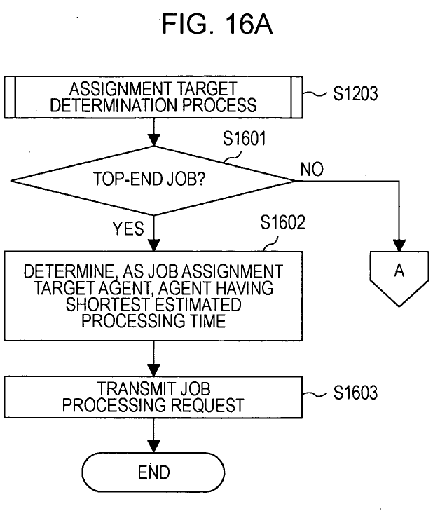

FIG. 16A is a flowchart (first half) showing a detailed processing procedure of the assignment target determination process (at S1203) shown in FIG. 12. First, the master M determines whether the produced job is a top-end job, i.e., an initially produced job (S1601). If the produced job is the top-end job (Yes in step S1601), the master M determines, as the assignment target agent, the agent having the shortest estimated processing time (at S1602).

Then, the master M transmits a job processing request to the determined assignment target agent (at S1603). The job assignment processing is thereby brought to an end. On the other hand, if the produced job is not the top-end job in step S1601 (No at S1601), the master M shifts to a flowchart of FIG. 16B.

FIG. 16B is a flowchart (second half) showing a detailed processing procedure of the assignment target determination process (at S1203) shown in FIG. 12. Referring to FIG. 16B, the master M extracts the shortest estimated processing time Tpik from among the estimated processing times calculated for each of all the agents (at S1604) and selects the agent, which provides the extracted estimated processing time Tpik, as a transfer target candidate to which is transferred the processing result held by the agent having processed the parent job (at S1605). Further, the master M calculates a transfer time Ttj to the selected transfer target candidate based on the above-mentioned formula (3) (at S1606) and compares the extracted estimated processing time Tpik with the transfer time Ttj (at S1607).

If Tpik<Ttj is not satisfied (No at S1607), it is an indication that the transfer time Ttj is shorter than the extracted estimated processing time Tpik. Therefore, the master M determines, as the job assignment target agent, the agent providing the extracted estimated processing time Tpik (at S1608). Then, the master M transmits a job processing request to the determined assignment target agent (at S1609).

Further, the master M determines whether the assignment target and the transfer target are the same agent (at S1610). If the assignment target and the transfer target are the same agent (Yes at S1610), the master M brings the assignment target determination process to an end without transmitting a transfer request and then returns to S1401. On the other hand, if both the targets are not the same agent (No at S1610), the master M transmits, to the agent holding the processing result of the parent job, a transfer request for transferring that processing result to the assignment target agent (at S1611). The assignment target determination process is thereby brought to an end.

If Tpik<Ttj is satisfied (Yes at S1607), the master M executes a cluster forming process (at S1612). The cluster forming process is a process of collecting plural jobs into a cluster, as to be described in detail later.

After the cluster forming process, the master M determines, as a cluster assignment target agent, the agent holding the processing result of the parent job (at S1613) and transmits a job processing request (exactly speaking, a cluster processing request) to the cluster assignment target agent (at S1614). As a result, a group of jobs forming the cluster is loaded into the cluster assignment target agent. The assignment target determination process is then brought to an end.

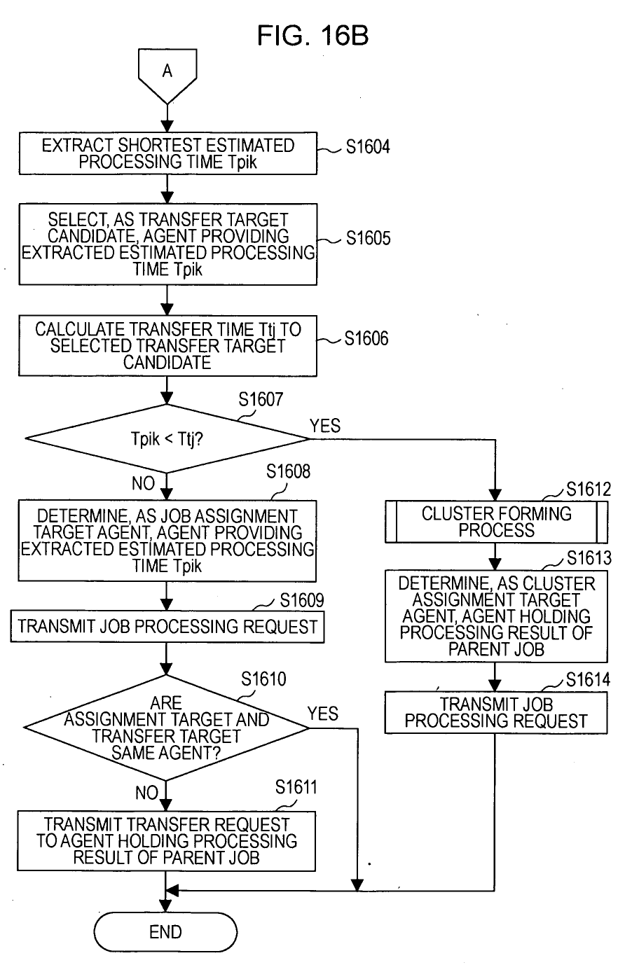

FIG. 17 is a flowchart showing a detailed processing procedure of the cluster forming process (at S1612) shown in FIG. 16B. First, the master M produces a cluster (at S1701). In this state, the cluster is an empty set. Then, the master M adds a job to the cluster (at S1702). Further, the master M produces another job having a parent common to the previously produced job (at S1703). In the example of FIG. 3, when the job J1-1 is added to the cluster, another job having a common parent (job J1) is produced. This job may become the job J1-2 as a result of the subsequent job ID assignment process.

Then, the master M executes the job ID assignment process (at S1704) and the estimated processing time calculation process (at S1705). The job ID assignment process (at S1704) is the same as the job ID assignment process shown in FIG. 13, and the estimated processing time calculation process (at S1705) is the same as the estimated processing time calculation process shown in FIGS. 14 and 15. Thereafter, the master M calculates a transfer time Ttj to the selected transfer target candidate based on the above-mentioned formula (3) (at S1706) and compares the extracted estimated processing time Tpik with the transfer time Ttj (at S1707).

If Tpik<Ttj is satisfied (Yes S1707), it is an indication that the extracted estimated processing time Tpik is shorter than the transfer time Ttj. Therefore, the master M adds the relevant job to the cluster (at S1708). Then, the master M compares an extracted estimated processing time ΣTpik of the cluster including the job added to it with the transfer time Ttj (at S1709). As referred herein, an “extracted estimated processing time ΣTpik of the cluster” indicates a total of respective extracted estimated processing times Tpik for the group of jobs added to the cluster.

If ΣTpik<Ttj is satisfied (Yes at S1709), it is an indication that that the cluster still has a margin. Therefore, the master M determines whether the production of the job having the common parent is completed (at S1710). On the other hand, if ΣTpik<Ttj is not satisfied (No at S1709), the master M brings the cluster forming process to an end and shifts to at S1613.

On the other hand, if Tpik<Ttj is not satisfied in step S1707 (No at S1707), the master M shifts to S1710 without adding the relevant job to the cluster. Then, the master M determines at S1710 whether the production of the job having the common parent is completed. If the job production is not yet completed (No at S1710), the master M returns to S1703. If the job production is completed (Yes at S1710), the master M brings the cluster forming process to an end and shifts to S1613.

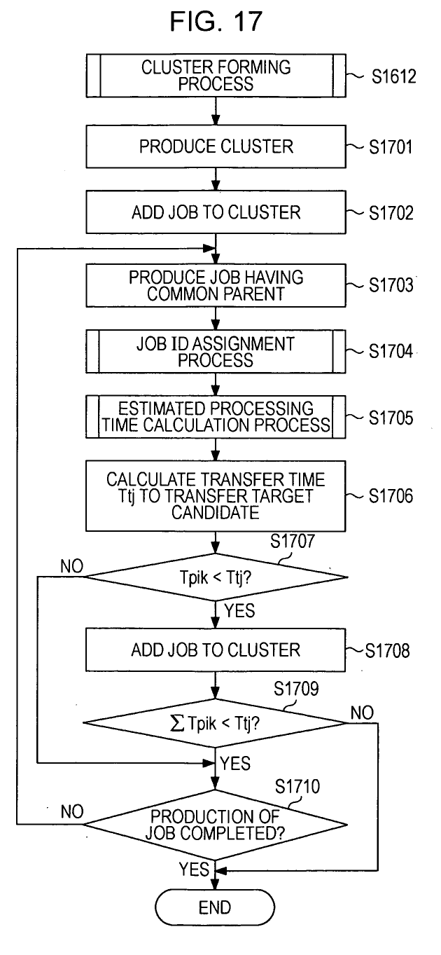

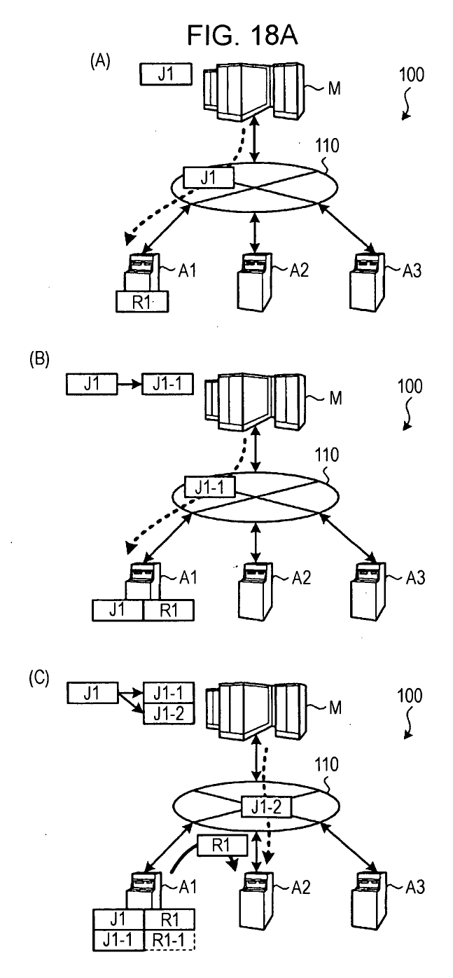

FIGS. 18A and 18B illustrate explanatory views showing decentralized processing of a series of jobs in time sequence of (A) to (F) according to an example embodiment. In (A) of FIG. 18A, the master M produces the top-end job J1 and determines, from among the agents A1 to A3, the agent A1 as the assignment target agent for the job J1. Then, the master M loads the job J1 into the agent A1.

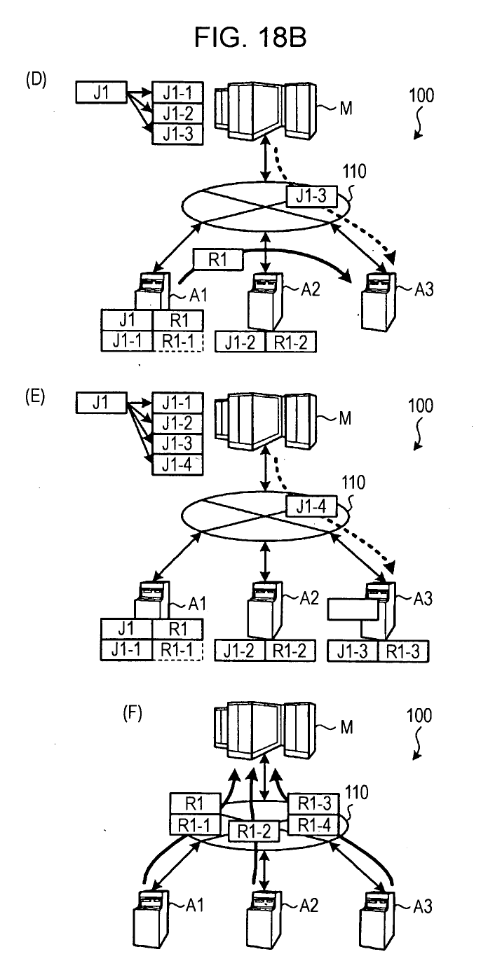

FIG. 19 illustrates the contents stored in the job management table 600 when an assignment target for the job J1 is determined in (A) of FIG. 18A according to an example embodiment. Referring to FIG. 19, because the processing time of the job J1, the processing time of a job having a parent common to the job J1, and the processing time of a job having a size comparable to that of the job J1 are all not registered, the estimated processing time is calculated for each of the agents A1 to A3 based on the above-mentioned formula (2). The agent A1 provides the shortest time among the calculated estimated processing times. Therefore, the assignment target for the job J1 is determined as the agent A1.

In (B) of FIG. 18A, when processing information is returned from the agent A1 into which the job J1 has been loaded, the master M registers the returned processing information in the job management table 600. Then, the master M produces the next job J1-1 and determines, from among the agents A1 to A3, the agent A1 as the assignment target agent for the job J1-1. The master M loads the job J1-1 into the agent A1. The job J1-1 is a job whose parent is the job J1, and it is processed by using the processing result R1 of the job J1.

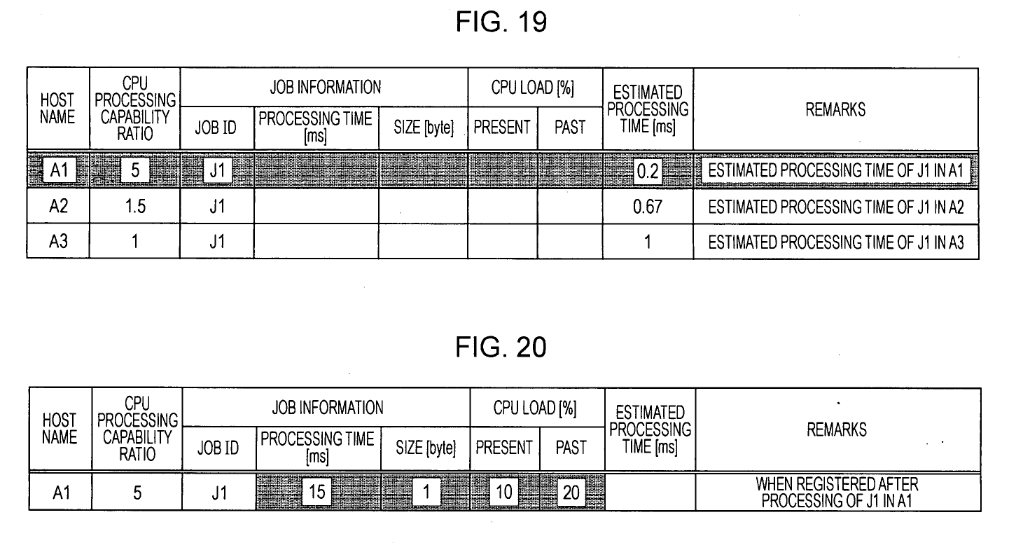

FIG. 20 illustrates the contents stored in the job management table 600 when the processing information of the job J1 is registered in (B) of FIG. 18A according to an example embodiment. In FIG. 20, 15 [ms] is registered as the processing time of the job J1, and 1 [byte] is registered as the data size of the job J1. Further, 10 [%] is registered as the present CPU load, and 20 [%] is registered as the past CPU load.

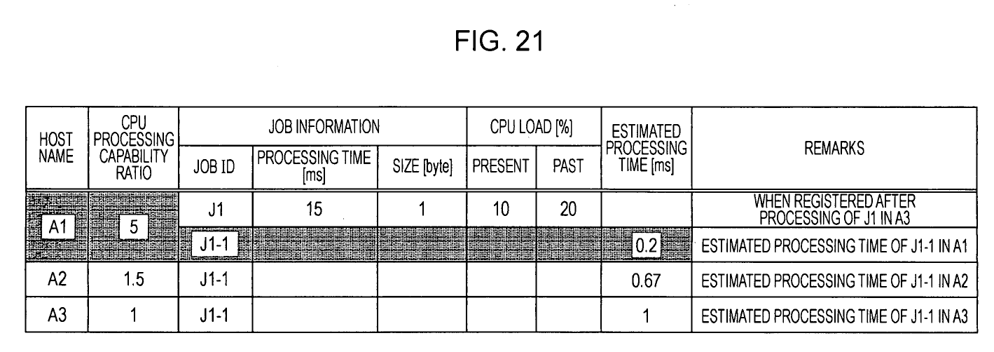

FIG. 21 illustrates the contents stored in the job management table 600 when assignment target candidates for the job J1-1 are narrowed in (B) of FIG. 18A according to an example embodiment. Referring to FIG. 21, because the processing time of the job J1-1, the processing time of a job having a parent common to the job J1-1, and the processing time of a job having a size comparable to that of the job J1-1 are all not registered as in FIG. 19, the estimated processing time is calculated for each of the agents A1 to A3 based on the above-mentioned formula (2). The agent A1 provides the shortest time among the calculated estimated processing times. Therefore, the assignment target candidates for the job J1-1 are narrowed to the agent A1.

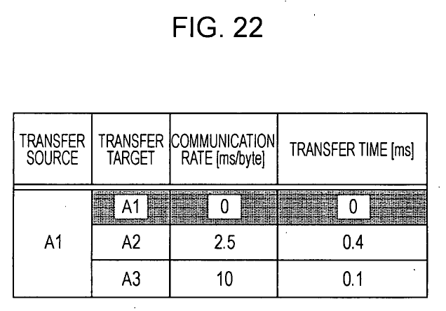

FIG. 22 illustrates an explanatory table showing transfer times to assignment target candidates for the job J1-1, which are registered in (B) of FIG. 18A according to an example embodiment. The master M refers to the communication rate management table 500 and calculates the transfer time to the assignment target candidate A1 for the job J1-1 with the transfer source of the processing result R1 being set to the agent A1. Comparing the estimated processing time with the transfer time, the transfer time is shorter than the estimated processing time. Accordingly, the agent A1 is determined as the assignment target of the job J1-1. Hence the processing result R1 is not required to be transferred.

In (C) of FIG. 18A, regardless of receiving the processing information of the job J1-1, the master M produces the next job J1-2. The job J1-2 is a job having a parent (job J1) common to the job J1-1, and it is processed by using the processing result R1 of the job J1. The master M determines the agent A2 as the assignment target of the job J1-2 and loads the job J1-2 into the agent A2.

Further, the master M transmits, to the agent A1, a request for transferring the processing result R1 of the job J1 to the agent A1. In response to the transfer request, the agent A1 transfers the processing result R1 to the agent A2. As a result, the agent A2 can execute processing of the job J1-2.

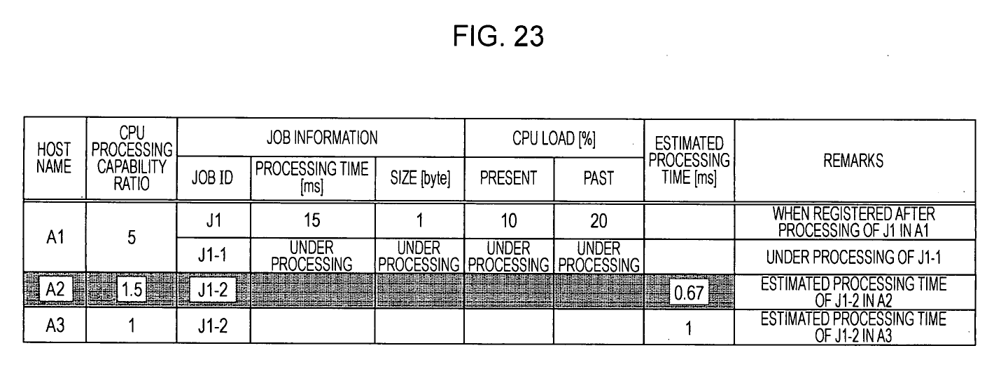

FIG. 23 illustrates the contents stored in the job management table 600 when assignment target candidates for the job J1-2 are narrowed in (C) of FIG. 18A according to an example embodiment. Referring to FIG. 23, because the agent A1 is under the processing of the job J1-1, it is excluded from the assignment target candidates. Also, in FIG. 23, because the processing time of the job J1-2, the processing time of a job having a parent common to the job J1-2, and the processing time of a job having a size comparable to that of the job J1-2 are all not registered as in FIG. 21, the estimated processing time is calculated for each of the agents A2 and A3 based on the above-mentioned formula (2). The agent A2 provides the shortest time among the calculated estimated processing times. Therefore, the assignment target candidates for the job J1-2 are narrowed to the agent A2.

Further, the master M refers to the communication rate management table 500 and calculates the transfer time to the assignment target candidate A2 for the job J1-2, as shown in FIG. 22, with the transfer source of the processing result R1 being set to the agent A1. Comparing the estimated processing time with the transfer time, the transfer time is shorter than the estimated processing time. Accordingly, the agent A2 is determined as the assignment target of the job J1-2. In this case, the agent A2 will become also the transfer target of the processing result R1.

In (D) of FIG. 18B, regardless of receiving the processing information of the jobs J1-1 and J1-2, the master M produces the next job J1-3. The job J1-3 is a job having a parent (job J1) common to the job J1-1, and it is processed by using the processing result R1 of the job J1. The master M determines the agent A3 as the assignment target of the job J1-3 and loads the job J1-3 into the agent A3.

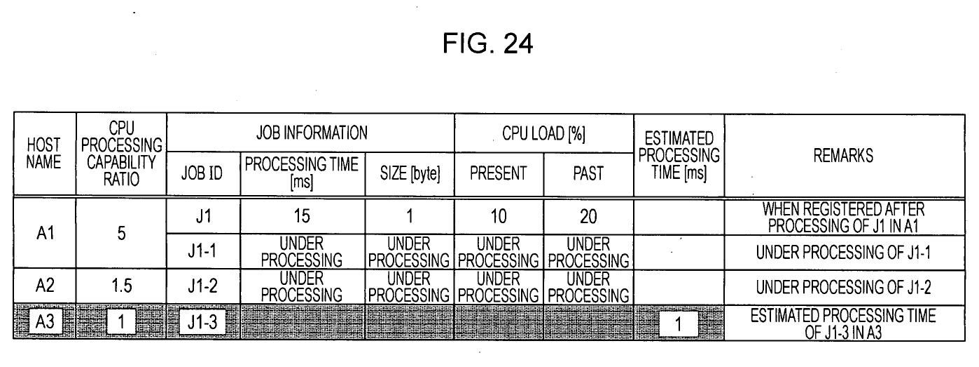

FIG. 24 illustrates the contents stored in the job management table 600 when assignment target candidates for a job J1-3 are narrowed in (D) of FIG. 18B according to an example embodiment. Referring to FIG. 24, because the agents A1 and A2 are under the processing of the jobs J1-1 and J1-2, respectively, they are excluded from the assignment target candidates. Also, in FIG. 24, because the processing time of the job J1-3, the processing time of a job having a parent common to the job J1-3, and the processing time of a job having a size comparable to that of the job J1-3 are all not registered as in FIG. 23, the estimated processing time is calculated for the agent A3 based on the above-mentioned formula (2). Herein, since only the estimated processing time of the agent A3 is present, the assignment target candidate for the job J1-3 is determined as the agent A3.

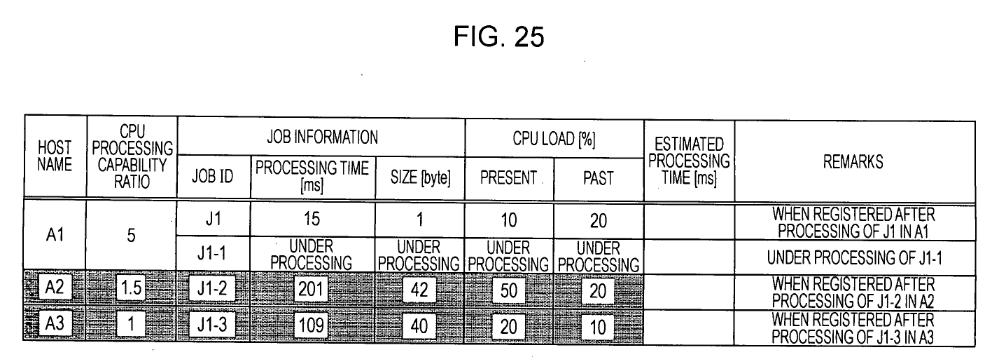

FIG. 25 illustrates the contents stored in the job management table 600 after processing information of the jobs J1-2 and J1-3 has been registered according to an example embodiment. In the state shown in FIG. 25, the job J1-1 is still under processing.

In (E) of FIG. 18B, regardless of receiving the processing information of the job J1-1, the master M produces the next job J1-4. The job J1-4 is a job having a parent (job J1) common to the job J1-1, and it is processed by using the processing result R1 of the job J1. The master M determines the agent A3 as the assignment target of the job J1-4 and loads the job J1-4 into the agent A3.

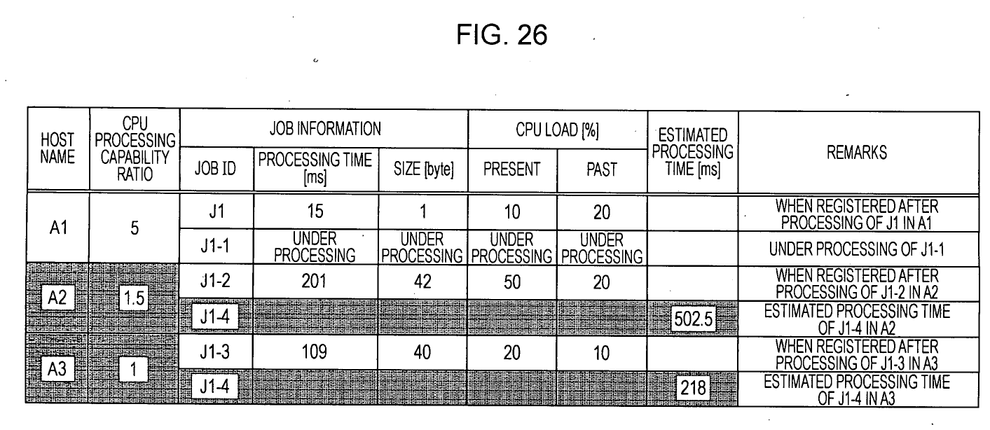

FIG. 26 illustrates the contents stored in the job management table 600 when assignment target candidates for the job J1-4 are narrowed in (E) of FIG. 18B according to an example embodiment. Referring to FIG. 26, because the agent A1 is under the processing of the job J1-1, it is excluded from the assignment target candidates. Also, in FIG. 26, because the processing times of the jobs J1-2 and J1-3 each having a parent common to the job J1-3 are registered, the estimated processing time is calculated for each of the agents A2 and A3 based on the above-mentioned formula (1). The agent A3 provides the shortest time among the calculated estimated processing times. Therefore, the assignment target candidates for the job J1-4 are narrowed to the agent A3.

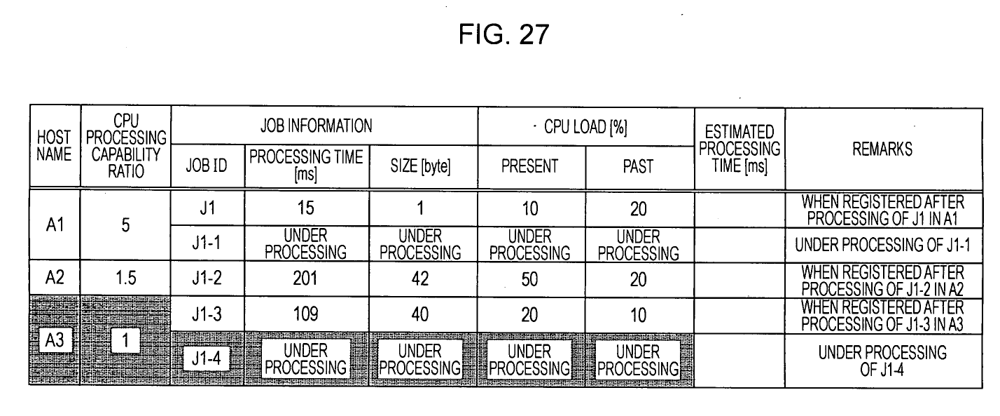

FIG. 27 illustrates the contents stored in the job management table 600 when the assignment target of the job J1-4 has been determined in (E) of FIG. 18B according to an example embodiment. After the completion of the processing of all the jobs, upon receiving, from the master M, requests for acquiring the processing results R1 and R1-1 to R1-4 held in the assignment target agents A1 to A3, the assignment target agents A1 to A3 return the processing results R1 and R1-1 to R1-4 to the master M in (F) of FIG. 18B.

According to the embodiment (including examples), as described above, because the processing result of the job processed by some agent is directly transferred to another agent without passing the master M, the transfer time of the job processing result between the agents under management of the master M may be shortened.

Also, when the assignment target is determined, a job before loading may be assigned to the agent having higher processing efficiency by calculating the estimated processing time of the job per agent during the loading of a preceding job. Accordingly, the total processing time of all the jobs may be shortened. In addition, the estimated processing time may be more easily calculated with higher accuracy by referring to the processing time of the same or similar job.

Further, when the assignment target is determined, the transfer time of the processing result is calculated by referring to the communication rate between the agents. Accordingly, the agent having a shorter transfer time may be determined as the job assignment target and the transfer time of the processing result may be cut.

The number of times of transfers of the processing results may also be cut by collecting a group of jobs, which have a total of their estimated processing times shorter than the transfer time, into a cluster and by loading the group of jobs together into the agent holding the processing result which is to be used in processing the group of jobs. In addition, the efficiency of the job processing may be increased, the agent load may be reduced, and the entire processing time of all the jobs may be cut.

Accordingly, the grid computing system as described above in various example embodiments may shorten the processing time of a series of jobs and reduce traffic on the network 110 between the master M and the agent group.

Also, various example embodiments as described above for a decentralized processing method may be realized by executing a program, which is prepared in advance, with a computer, such as a personal computer or a work station. The program is recorded on a computer-readable recording medium, such as a hard disk, a flexible disk, a CD-ROM, an MO, or a DVD, and is executed by reading it from the recording medium with the computer. The program may be prepared in the form of a medium distributable via the network 110, e.g., the Internet.

Further, the decentralized processing apparatus described in the embodiment also may be realized with an Application Specific Integrated Circuit (hereinafter abbreviated to an “ASIC”), such as a standard cell or a structured ASIC, or a PLD (Programmable Logic Device), e.g., an FPGA (Field Programmable Gate Array). More specifically, the decentralized processing apparatus can be manufactured, for example, by defining the above-described functions 801 to 808 and 901 to 904 of the decentralized processing apparatus in HDL descriptions and by providing those HDL descriptions to the ASIC or the PLD after logical synthesis thereof.

Many features and advantages of the embodiments of the invention are apparent from the detailed specification and, thus, it is intended by the appended claims to cover all such features and advantages of the embodiments that fall within the true spirit and scope thereof. Further, because numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A method for decentralized processing in a network including a master computing machine and a plurality of agent computing machines, the method comprising:
detecting that processing of a first job is completed by a first one of the plurality of agent computing machines which is an assignment target of the first job;
producing a second job which is to be processed by using a processing result of the first job;
determining a second one of the plurality of agent computing machines to process the produced second job, when the completion of the processing of the first job is detected; and
transmitting the produced second job to the second agent computing machine as determined to process the produced second job; and
requesting the first agent computing machine to transmit, without passing through the master computing machine, the processing result of the first job to the second agent computing machine.

2. The method of claim 1, further comprising:
calculating an estimated processing time of the second job for each of assignment target candidates of the second job, which are selected from the plurality of agent computing machines, and the second agent computing machine is one of the assignment target candidates.

3. The method of claim 2, wherein determining the second agent computing machine comprises:
determining the second agent computing machine as the assignment target from among the assignment target candidates based on the estimated processing time calculated for each of the assignment target candidates.

4. The method of claim 3, wherein calculating the estimated processing time of the second job comprises:
calculating the estimated processing time of the second job based on a processing time of a job similar to the second job.

5. The method of claim 4, wherein the similar job is a job which has been processed in any of the assignment target candidates earlier than the second job by using the processing result of the first job.

6. The method of claim 4, wherein the similar job is a job which has been processed in any of the assignment target candidates earlier than the second job, and which has a data size comparable to that of the second job.

7. The method of claim 2, further comprising:
acquiring a communication rate between the first agent computing machine of the first job and at least one of the assignment target candidates of the second job;
wherein the calculating procedure calculates a transfer time of the processing result of the first job from the assignment target of the first job to the assignment target candidate of the second job based on a data size of the processing result and the acquired communication rate.

8. The method of claim 7, wherein determining the second agent computing machine from among the assignment target candidates by comparing the estimated processing time with the calculated transfer time.

9. The method of claim 8, wherein determining the second agent computing machine comprises:
determining the second agent computing machine as one of the assignment target candidates which has the transfer time shorter than the estimated processing time.

10. The method of claim 7, further comprising:
upon the transfer time being longer than the estimated processing time,
successively producing a third job which is to be processed by using the processing result of the first job, and
collecting the first job, second job, and the third job into a cluster.

11. The method of claim 10, wherein determining the second agent computing machine comprises:
determining the second agent computing machine as an assignment target to process the cluster, whereby the first and second agent computing machines are one and the same.

12. The method of claim 10, further comprising:
calculating an estimated processing time of the third job based on a processing capability of the determined assignment target to process the third job whenever the third job is produced, and
adding the third job to the cluster when the calculated estimated processing time of the third job is shorter than the transfer time.

13. The method of claim 10, wherein collecting the first job, second job, and third job into the cluster comprises:
adding the third job, which is successively produced, to the cluster such that a total of the estimated processing times of the jobs making up the cluster exceeds the transfer time.

14. The method of claim 1, wherein detecting that processing of the first job is completed comprises:
detecting a completion of processing of all jobs by the plurality of agent computing machines in the network;
wherein upon the detection of the completion of processing of all jobs in the network,
transmitting, to those agent computing machines to which the jobs have been assigned, a request for acquiring processing results of the jobs, and
receiving the processing results of the jobs in response to the acquisition request.

15. A decentralized processing apparatus for causing a group of agents to execute decentralized processing, the decentralized processing apparatus comprising:
a detecting unit to detect that processing of a first job is completed by an agent which is an assignment target of the first job;
a producing unit to produce a second job which is to be processed by using a processing result of the first job, when the completion of the processing of the first job is detected;
a determining unit to determine an agent, which is an assignment target of the produced second job, from among the agent group;
a communicating unit to communicate with the agent group; and
a control unit to control the communicating unit such that a request for processing the second job is transmitted to the determined agent and a transfer request for transferring the processing result of the first job from the assignment target agent of the first job to the assignment target agent of the second job is transmitted to the assignment target agent of the first job.

16. A computer-readable recording medium that stores therein a decentralized processing program for causing a group of agents to execute decentralized processing, the program making a computer execute:
detecting that processing of a first job is completed by a first one of the plurality of agent computing machines which is an assignment target of the first job;
producing a second job which is to be processed by using a processing result of the first job;
determining a second one of the plurality of agent computing machines to process the produced second job, when the completion of the processing of the first job is detected; and
transmitting the produced second job to the second agent computing machine as determined to process the produced second job; and
requesting the first agent computing machine to transmit, without passing through the master computing machine, the processing result of the first job to the second agent computing machine.
